(19) United States
(12) Patent Application Publication
(10) Pub. No.: US 2025/0056183 A1
(43) Pub. Date: Feb. 13, 2025

(54) ACCESS POINT SELECTION FOR UE PROXIMITY DETECTION

(71) Applicant: Samsung Electronics Co., Ltd., Suwon-si (KR)

(72) Inventors: Samuel Albert, Robbinsville, NJ (US); Xiaochuan Ma, Hillsborough, NJ (US); Daoud Burghal, San Jose, CA (US); Hao Chen, Allen, TX (US); Russell Douglas Ford, Campbell, CA (US); Yan Xin, Princeton, NJ (US); Jianzhong Zhang, Dallas, TX (US)

(21) Appl. No.: 18/793,492

(22) Filed: Aug. 2, 2024

Related U.S. Application Data
(60) Provisional application No. 63/532,317, filed on Aug. 11, 2023.

(51) Int. Cl. H04W 4/021; H04W 84/12

(52) U.S. Cl. CPC H04W 4/021; H04W 84/12

(57) ABSTRACT

A method includes selecting a subset of access points from among multiple candidate access points associated with a building. The method also includes receiving Wi-Fi signal strength data from the subset of access points. The method further includes using a machine learning (ML) localization algorithm to determine a proximity of a device within the building based on the received Wi-Fi signal strength data.

### CROSS-REFERENCE TO RELATED APPLICATION(S) AND CLAIM OF PRIORITY

This application claims priority under 35 U.S.C. § 119(e) to U.S. Provisional Patent Application No. 63/532,317, filed on Aug. 11, 2023, which is hereby incorporated by reference in its entirety.

### TECHNICAL FIELD

This disclosure relates generally to wireless communications systems. Embodiments of this disclosure relate to methods and apparatuses for access point selection for UE proximity detection.

### BACKGROUND

Room proximity detection techniques are being developed to accurately determine the presence and proximity of individuals within a specific area or room. Research related to these techniques has gained significant attention due to its potential applications in various domains, including smart home automation, workplace optimization, healthcare monitoring, security systems, personalized services, and the like.

### SUMMARY

Embodiments of the present disclosure provide methods and apparatuses for access point selection for UE proximity detection.

In one embodiment, a method includes selecting a subset of access points from among multiple candidate access points associated with a building. The method also includes receiving Wi-Fi signal strength data from the subset of access points. The method further includes using a machine learning (ML) localization algorithm to determine a proximity of a device within the building based on the received Wi-Fi signal strength data.

In another embodiment, a device includes a transceiver and a processor operably connected to the transceiver. The processor is configured to: select a subset of access points from among multiple candidate access points associated with a building; receive Wi-Fi signal strength data from the subset of access points; and use a ML localization algorithm to determine a proximity of the device within the building based on the received Wi-Fi signal strength data.

In another embodiment, a non-transitory computer readable medium includes program code that, when executed by a processor of a device, causes the device to: select a subset of access points from among multiple candidate access points associated with a building; receive Wi-Fi signal strength data from the subset of access points; and use a ML localization algorithm to determine a proximity of the device within the building based on the received Wi-Fi signal strength data.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2A illustrates an example AP according to embodiments of the present disclosure;

FIG. 2B illustrates an example STA according to embodiments of the present disclosure;

FIG. 3 illustrates an example Wi-Fi system according to embodiments of the present disclosure;

FIG. 4 illustrates an example system for importance-based AP selection according to embodiments of the present disclosure;

FIG. 5 illustrates an example process for importance-based AP selection according to embodiments of the present disclosure;

FIG. 6 illustrates an example process for importance-based AP selection using information theory-based metrics according to embodiments of the present disclosure;

FIG. 7 illustrates an example process for performing a Maxmean preprocessing technique according to embodiments of this disclosure;

FIG. 8 illustrates an example process for performing a missing data filtering technique according to embodiments of this disclosure;

FIG. 9 illustrates an example process for mutual information-based AP selection according to embodiments of the present disclosure; and

FIG. 10 illustrates a flow chart of a method for access point selection for UE proximity detection according to embodiments of the present disclosure.

### DETAILED DESCRIPTION

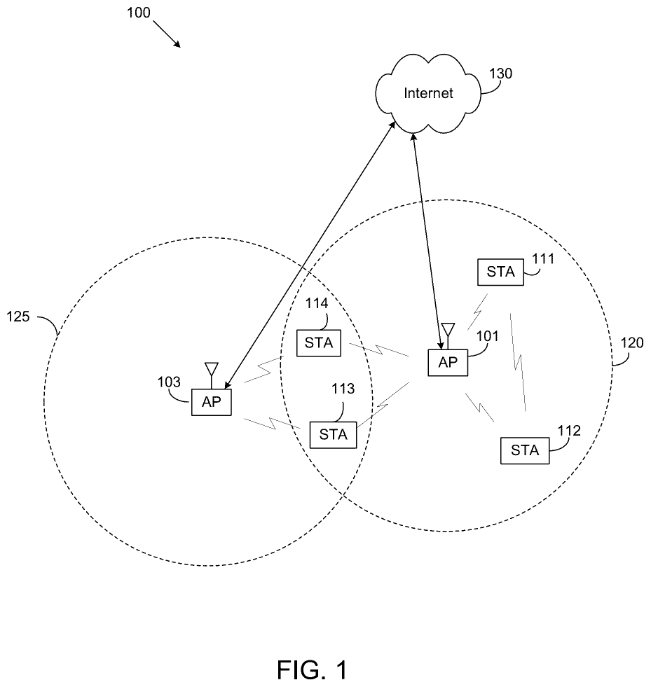

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

The present disclosure covers several components which can be used in conjunction or in combination with one another or can operate as standalone schemes. Certain embodiments of the disclosure may be derived by utilizing a combination of several of the embodiments listed below. Also, it should be noted that further embodiments may be derived by utilizing a particular subset of operational steps as disclosed in each of these embodiments. This disclosure should be understood to cover all such embodiments.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN (wireless local area network) communication techniques. The STAs 111-114 may communicate with each other using peer-to-peer protocols, such as Tunneled Direct Link Setup (TDLS).

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming to enable access point selection for UE proximity detection. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provide STAs with direct wireless broadband access to the network 130. Further, the APs 101 and/or 103 could provide access to other or additional external networks, such as external telephone networks or other types of data networks.

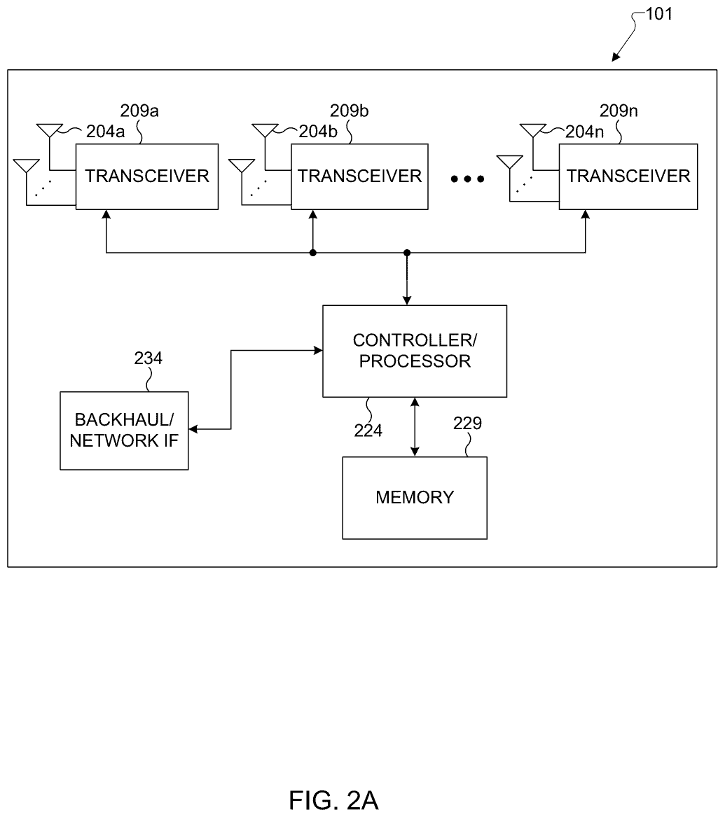

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

The AP 101 includes multiple antennas 204a-204n and multiple transceivers 209a-209n. The AP 101 also includes a controller/processor 224, a memory 229, and a backhaul or network interface 234. The transceivers 209a-209n receive, from the antennas 204a-204n, incoming radio frequency (RF) signals, such as signals transmitted by STAs 111-114 in the network 100. The transceivers 209a-209n down-convert the incoming RF signals to generate IF or baseband signals. The IF or baseband signals are processed by receive (RX) processing circuitry in the transceivers 209a-209n and/or controller/processor 224, which generates processed baseband signals by filtering, decoding, and/or digitizing the baseband or IF signals. The controller/processor 224 may further process the baseband signals.

Transmit (TX) processing circuitry in the transceivers 209a-209n and/or controller/processor 224 receives analog or digital data (such as voice data, web data, e-mail, or interactive video game data) from the controller/processor 224. The TX processing circuitry encodes, multiplexes, and/or digitizes the outgoing baseband data to generate processed baseband or IF signals. The transceivers 209a-209n up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the transceivers 209a-209n in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including enabling access point selection for UE proximity detection. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for access point selection for UE proximity detection. Although FIG. 2A illustrates one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. Alternatively, only one antenna and transceiver path may be included, such as in legacy APs. Also, various components in FIG. 2A could be combined, further subdivided, or omitted and additional components could be added according to particular needs.

FIG. 2B illustrates an example STA 111 according to various embodiments of the present disclosure. The embodiment of the STA 111 illustrated in FIG. 2B is for illustration only, and the STAs 112-114 of FIG. 1 could have the same or similar configuration. However, STAs come in a wide variety of configurations, and FIG. 2B does not limit the scope of this disclosure to any particular implementation of a STA.

The STA 111 includes antenna(s) 205, transceiver(s) 210, a microphone 220, a speaker 230, a processor 240, an input/output (I/O) interface (IF) 245, an input 250, a display 255, and a memory 260. The memory 260 includes an operating system (OS) 261 and one or more applications 262.

The transceiver(s) 210 receives from the antenna(s) 205, an incoming RF signal (e.g., transmitted by an AP 101 of the network 100). The transceiver(s) 210 down-converts the incoming RF signal to generate an intermediate frequency (IF) or baseband signal. The IF or baseband signal is processed by RX processing circuitry in the transceiver(s) 210 and/or processor 240, which generates a processed baseband signal by filtering, decoding, and/or digitizing the baseband or IF signal. The RX processing circuitry sends the processed baseband signal to the speaker 230 (such as for voice data) or is processed by the processor 240 (such as for web browsing data).

TX processing circuitry in the transceiver(s) 210 and/or processor 240 receives analog or digital voice data from the microphone 220 or other outgoing baseband data (such as web data, e-mail, or interactive video game data) from the processor 240. The TX processing circuitry encodes, multiplexes, and/or digitizes the outgoing baseband data to generate a processed baseband or IF signal. The transceiver(s) 210 up-converts the baseband or IF signal to an RF signal that is transmitted via the antenna(s) 205.

The processor 240 can include one or more processors and execute the basic OS program 261 stored in the memory 260 in order to control the overall operation of the STA 111. In one such operation, the processor 240 controls the reception of forward channel signals and the transmission of reverse channel signals by the transceiver(s) 210 in accordance with well-known principles. The processor 240 can also include processing circuitry configured to enable access point selection for UE proximity detection. In some embodiments, the processor 240 includes at least one microprocessor or microcontroller.

The processor 240 is also capable of executing other processes and programs resident in the memory 260, such as operations for enabling access point selection for UE proximity detection. The processor 240 can move data into or out of the memory 260 as required by an executing process. In some embodiments, the processor 240 is configured to execute a plurality of applications 262, such as applications to enable access point selection for UE proximity detection. The processor 240 can operate the plurality of applications 262 based on the OS program 261 or in response to a signal received from an AP. The processor 240 is also coupled to the I/O interface 245, which provides STA 111 with the ability to connect to other devices such as laptop computers and handheld computers. The I/O interface 245 is the communication path between these accessories and the processor 240.

The processor 240 is also coupled to the input 250, which includes for example, a touchscreen, keypad, etc., and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As discussed earlier, room proximity detection techniques are being developed to accurately determine the presence and proximity of individuals within a specific area or room. Research related to these techniques has gained significant attention due to its potential applications in various domains, including smart home automation, workplace optimization, healthcare monitoring, security systems, personalized services, and the like.

Smart Home Automation: In the context of smart homes, room proximity detection can enable seamless automation of various tasks. For example, when a person enters a room, the system can adjust the lighting, temperature, and entertainment settings based on their preferences. Similarly, when someone leaves a room, the system can automatically turn off unnecessary appliances to conserve energy. Accurate room proximity detection is important for creating personalized and responsive smart home environments.

Workplace Optimization: Room proximity detection can play a vital role in optimizing workplaces and enhancing productivity. By tracking the presence and movement of employees, organizations can analyze space utilization patterns, identify bottlenecks, and make informed decisions regarding office layouts, resource allocation, and facility management. This data-driven approach can lead to improved workflow efficiency and a better work environment.

Healthcare Monitoring: In healthcare settings, room proximity detection can assist in patient monitoring and safety. For instance, by detecting when a patient enters or exits a room, healthcare professionals can receive timely notifications, ensuring prompt assistance and care. Additionally, room proximity detection can be integrated with other health monitoring systems to track patients' movements, ensuring their safety within healthcare facilities.

Security Systems: Room proximity detection can enhance the effectiveness of security systems by providing real-time information about the presence of individuals in restricted or sensitive areas. This can help prevent unauthorized access, monitor occupancy in specific zones, and trigger alerts or alarms when required. By accurately detecting room proximity, security systems can respond swiftly to potential threats or unusual activities, bolstering overall safety measures.

Personalized Services: Room proximity detection can enable personalized services in various contexts. For example, in retail environments, knowing a customer's presence in a particular section can trigger tailored promotions or recommendations. In museums or exhibition halls, proximity detection can provide interactive and informative experiences by delivering relevant content based on the visitor's location. Such personalized services can enhance user engagement and satisfaction.

Overall, the motivation behind room proximity detection research lies in the potential to create intelligent systems that can accurately detect and respond to the presence and proximity of individuals. By leveraging this technology, various domains can benefit from improved automation, optimized resource utilization, enhanced safety measures, and personalized experiences.

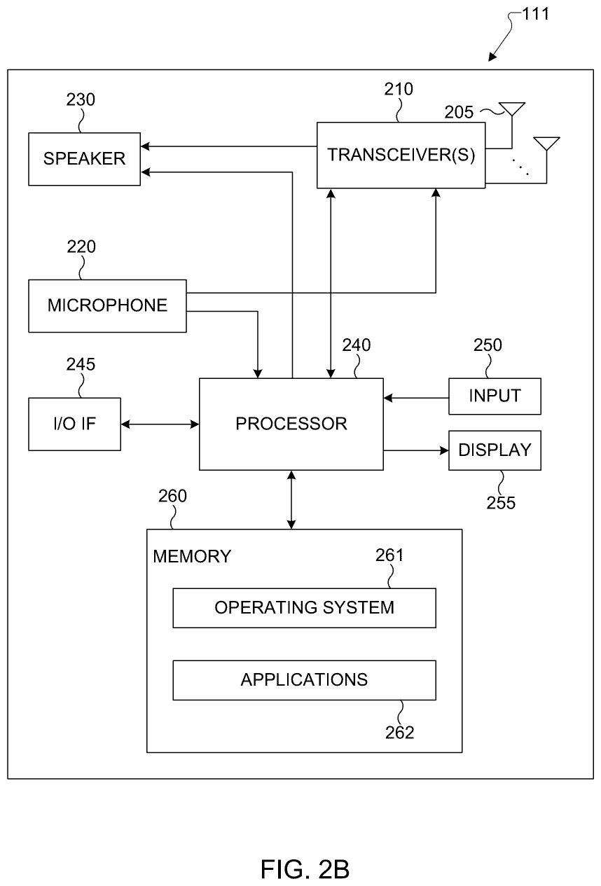

Room proximity detection can be achieved through different technologies, such as Wi-Fi, Bluetooth, Zigbee, and RFID. Currently, Wi-Fi is one of the most commonly used technologies due to its widespread availability in indoor environments. FIG. 3 illustrates an example Wi-Fi system 300 according to embodiments of the present disclosure. As shown in FIG. 3, the system 300 is disposed in conjunction with a building 302 and includes multiple APs 304 both within and outside the building 302. A UE 306 (e.g., a cell phone) is located in one of the rooms of the building 302 and can receive signals from multiple ones of the APs 304, both internal and external to the building 302.

In the context of room proximity detection, AP selection plays a crucial role in ensuring efficient and reliable communication within confined spaces. First, APs act as the backbone infrastructure for wireless communication, enabling the transmission of data from sensors or devices to a central processing unit. The selection of APs with suitable coverage and signal strength is important to ensure reliable data transmission within the proximity detection system. The right AP selection can help mitigate issues like signal attenuation or loss, which could adversely affect proximity detection accuracy. Second, AP selection in proximity detection systems can also involve choosing APs strategically to optimize the detection accuracy. By considering factors such as signal strength, signal-to-noise ratio, or the number of neighboring APs, it is possible to identify the most suitable APs for proximity detection in a given area. This optimization can help eliminate false positives or false negatives in the detection process, leading to more accurate and reliable results. In addition, the process of scanning nearby UEs can be time and power consuming. Therefore, the identification of key access points to scan is important for reducing the time and power required for resolving localization.

The following list includes some key factors and considerations involved in access point selection for room proximity detection:

1. Coverage Area: Access points should be strategically placed to ensure sufficient coverage across the indoor environment. The number and placement of APs depend on the size and complexity of the building, the density of obstacles, and the desired level of accuracy.

2. Signal Strength: The strength of the signals received from the access points is important for accurate localization. Strong signals provide better distance estimates, leading to improved localization accuracy.

3. Signal Quality: The quality of the received signals, including signal-to-noise ratio and multipath effects, can affect the accuracy of localization. High-quality signals are important for reducing localization errors.

4. Overlapping Coverage: Overlapping coverage areas between access points help in minimizing dead zones and improving localization accuracy, especially in areas with obstacles or signal attenuation.

5. Localization Algorithm: The choice of localization algorithm also impacts access point selection. Some algorithms may require more access points to achieve higher accuracy, while others may be more efficient with fewer APs.

6. Data Fusion: Integration of data from multiple sources, such as Wi-Fi, Bluetooth, and other sensors, can enhance localization accuracy. The selection of access points should consider their compatibility with other sensor data sources.

7. Dynamic Environments: In dynamic indoor environments where the layout or obstacles change over time, adaptive access point selection algorithms may be used to ensure continuous and reliable localization.

8. Power Consumption: Power-efficient access point selection is important for IoT devices or battery-powered mobile devices to prolong their operational life.

9. Security and Privacy: In applications where privacy is a concern (e.g., healthcare or tracking sensitive assets), access point selection should consider secure communication protocols and privacy-preserving techniques.

Overall, access point selection in room proximity detection involves a careful balance of signal coverage, signal quality, localization algorithms, and environmental factors to achieve accurate and reliable indoor positioning. The goal is to create a robust and efficient localization system that caters to the specific requirements of the application and provides valuable location-based services in indoor settings. Various methods and algorithms have been developed to optimize access point selection for Room proximity detection systems. Some conventional methods include:

1. Signal Strength-Based Selection: This method relies on measuring the received signal strength (RSS) from different access points at the mobile device's location. Access points with the strongest signals are selected for localization, as they indicate proximity to the mobile device. Signal strength-based selection is simple and widely used, but it may suffer from inaccuracies due to multipath interference and signal attenuation caused by obstacles.

2. Fingerprinting-Based Selection: Fingerprinting involves creating a radio map of the indoor environment by collecting RSS data from various access points at known locations. During localization, the mobile device's RSS measurements are compared to the radio map, and the closest match is used to estimate the device's position. Fingerprinting can provide high accuracy but requires extensive initial calibration and periodic updates to accommodate changes in the environment.

3. Trilateration or Triangulation: Trilateration estimates the mobile device's position by intersecting the circles (in 2D) or spheres (in 3D) formed by the distances between the device and at least three access points with known locations. Triangulation, on the other hand, estimates position by measuring angles between the device and multiple access points, requiring a minimum of three access points for 2D localization and four for 3D localization. Trilateration and triangulation methods are commonly used in combination with other techniques to enhance accuracy. A limitation of these approaches is precise knowledge of the location of the access points in the environment, which is very rare for cases such as private homes.

4. Proximity Graphs: Proximity graphs model the relationship between access points and their distances to create a graph representation of the indoor environment. The mobile device's proximity to access points is used to identify the nearest neighbors in the graph, and localization is achieved based on these relationships. Proximity graphs are suitable for environments with irregular layouts or complex obstacles. Again, knowledge of the precise locations of the access points is required for the distance calculation, which may not be available.

5. Machine Learning-Based Approaches: Machine learning algorithms, such as support vector machines (SVMs), k-nearest neighbors (k-NNs), random forests, or deep learning methods, can be applied for access point selection and localization. These algorithms learn from training data to estimate the mobile device's position based on received signal strength indicator (RSSI) measurements and other contextual information. Machine learning is generally data hungry, and to operate in real time, it is configured to work within the limitations of real time data collection.

The choice of an access point selection method depends on factors such as the complexity of the indoor environment, available infrastructure, required accuracy, and the type of devices used for localization. Combining multiple methods or using hybrid approaches can further enhance the performance and reliability of room proximity detection systems.

The limitations of techniques 1-4 described above provide strong motivation for a solution based on machine learning. Many current machine learning (ML) algorithms make assumptions about all data from a fixed set of APs available for measurement at a given time. Such data can be time consuming to collect, as a large range of frequencies may need to be scanned to sample all APs. Therefore, it is desirable if specific frequencies and their corresponding APs can be identified a priori to reduce the sampling burden. Further, to achieve good localization it is useful if the AP selection is closely associated with the ML algorithm intended for localization rather than a heuristic approach based on, for example, signal strength, etc.

Home automation systems (such as SMARTTHINGS by SAMSUNG ELECTRONICS) are useful for helping people interact with their homes. Such systems interact with users via voice commands issued to various home assistants such as BIXBY, ALEXA by AMAZON, and GOOGLE Home Assistant. Frequently the proper interpretation of a command requires contextual information. For example, a command such as “dim the light,” requires knowledge of the speaker's location to be actuated properly.

While accurate localization can be achieved with sensor arrays for motion, light, etc., most users do not have their homes equipped with enough devices to rely on this solution. An ideal solution would be nonintrusive and rely on devices a user already has. Given the ubiquity of cellphones with billions in use worldwide, a solution leveraging them is ideal. However, considerations must be given to battery consumption and response time. In particular, while signal strength measurement from nearby APs can be useful for accurately determining location, scanning for all nearby APs can consume excessive amounts of time and power. It is therefore important to identify as few as possible APs that can still perform accurate localization.

To address these and other issues, this disclosure provides systems and methods for access point selection for UE proximity detection. As described in more detail below, the disclosed embodiments provide data driven approaches to AP selection, which can be used in combination with any machine learning approach for localization. The disclosed embodiments can be used to select APs with the intention of reducing the amount of data that is sampled in real time to achieve good localization. Details are provided below for multiple techniques, including methods that seek directly to identify APs based on their importance to the ML procedure used for the localization, and also a combination of the basic AP selection methods and information theory-based AP selection methods. Some of the disclosed embodiments are described in the context of Wi-Fi based room proximity detection, however this disclosure is not limited thereto. The disclosed embodiments can be implemented in conjunction with other suitable communication protocols.

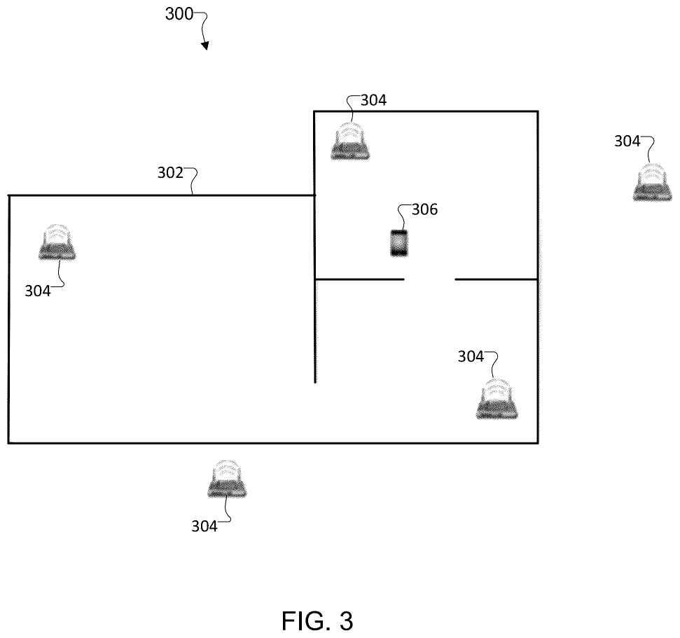

FIG. 4 illustrates an example system 400 for importance-based AP selection according to embodiments of the present disclosure. As shown in FIG. 4, the system 400 includes a data gathering apparatus 401, a similarity engine 403, a clustering engine 405, and a core ML localization algorithm 407.

The data gathering apparatus 401 refers collectively to the physical equipment used to collect the data as well as any preprocessing done to the data. This data can follow in either of two flows. In one flow, the data is sent directly from the data gathering apparatus 401 to the core ML localization algorithm 407. In the other flow, the similarity engine 403 applies a similarity technique to the vector of RSSIs of each pair of APs to generate a similarity measure. The clustering engine 405 then uses one or more clustering algorithms to group the APs based on this similarity score. The data augmented with the clustering information is then reprocessed through the core ML localization algorithm 407. Further details of the system 400 are provided below.

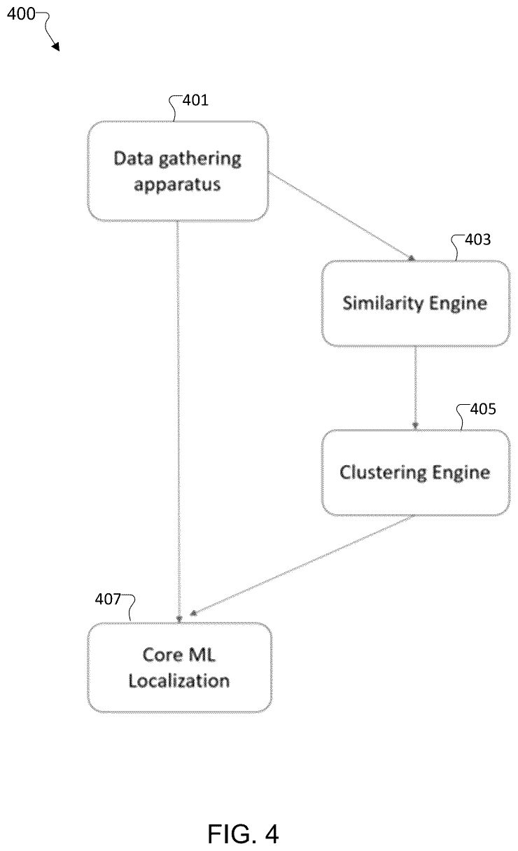

FIG. 5 illustrates an example process 500 for importance-based AP selection according to embodiments of the present disclosure. For ease of explanation, the process 500 is described as being performed using the system 400 of FIG. 4.

At operation 501, the system 400 collects location labeled data from available APs (e.g., by using the data gathering apparatus 401), and assembles the data into a matrix with each column (i.e., feature) corresponding to the RSSI data from one AP. A default value is substituted for any missing data. Then, a ML algorithm (e.g., a random forest classifier or any other suitable ML classifier) is trained on the full data, and a score (e.g., accuracy) is assigned to the quality of the solution.

At operation 503, the similarity engine 403 assigns a similarity measure to each pair of APs. Using (x₁ . . . , xₙ), (y₁, . . . , yₙ) to denote RSSI data from a pair of APs, some possible similarity measures are the Pearson correlation and the Kendall rank coefficient. The Pearson correlation can be defined as:

$${ρ}_{X , Y} = \frac{𝔼 [ X - {μ}_{X} ( Y - {μ}_{Y} ) ]}{{σ}_{X} {σ}_{Y}} .$$

The Kendall rank coefficient can be defined as

$$τ = \frac{2}{n ( n - 1 )} {\sum }_{i < j} sgn ( {x}_{i} - {x}_{j} ) sgn ( {y}_{i} - {y}_{j} ) .$$

At operation 505, the clustering engine 405 is applied to the calculated similarity measure to cluster the APs into groups. In some embodiments, the clustering engine 405 uses a clustering algorithm such as kmedoids, which is flexible with respect to the choice of distance metric. Since the appropriate number of clusters is not known in advance, the clustering engine 405 is applied for k=2:K, where K may be taken heuristically as, for example, (number of APs)/3.

At operation 507, the system 400 calculates the quality of the resulting clusters using a technique such as Silhouettes. Then, the system 400 considers the values k₁, k₂, and k₃ corresponding to the top three clustering results based on Silhouettes, and selects a nominal k*=mean (k₁, k₂, k₃), rounded to the nearest integer.

Operation 509 begins with an empty list for nominal APs. For each of the k* clusters, the system 400 randomly permutes the data from the APs of the corresponding cluster, refits the classifier to the modified data, and evaluates the score. At operation 511, if the reduction in accuracy exceeds a threshold, the system 400 adds the APs in the cluster to the nominal APs.

For example, in the case of a random forest classifier, the system 400 may repeat the initial calibration as well as the fitting of the permuted data enough times to obtain a large enough sample such that the system 400 can apply a statistical criterion to determine whether a reduction is significant. As a particular example, the system 400 can add APs to the nominal list when the reduction in accuracy is at least two standard deviations, assuming a bell-shaped distribution for the accuracy under multiple fittings of the random forest classifier.

### Information Theory Metric-Based AP Selection.

In some embodiments, when measuring the importance of the AP for room proximity detection, various metrics can be used that reflect how much useful information can be obtained from the AP. When a data set is available that includes fingerprints of all APs in different rooms, the importance of the APs can be measured from an information theory perspective.

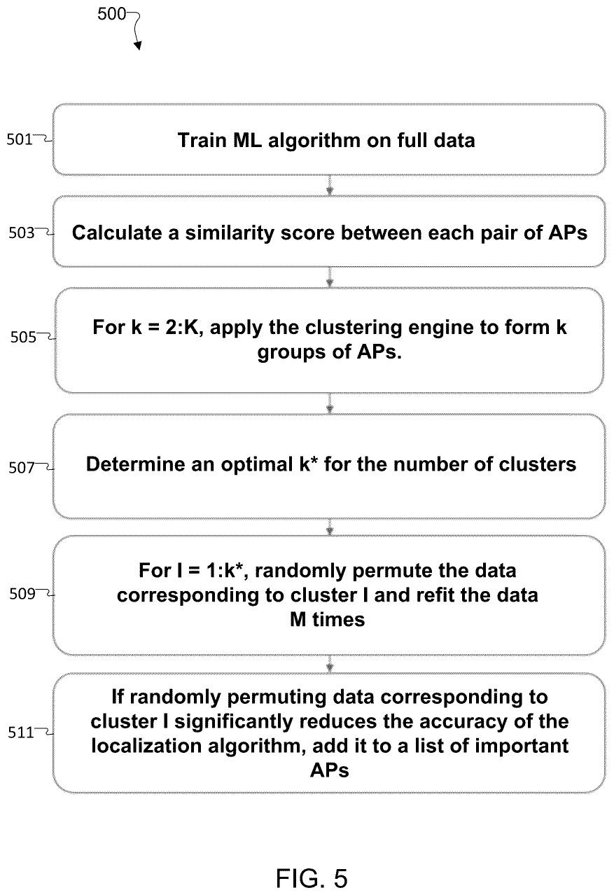

FIG. 6 illustrates an example process 600 for importance-based AP selection using information theory-based metrics according to embodiments of the present disclosure. As described in greater detail below, the process 600 can use various information theory-based metrics for AP selection.

As shown in FIG. 6, the process 600 starts with operation 601, in which the data of all APs is obtained into a dataset. Any suitable technique can be used for obtaining the data from the APs, including techniques described above. In some embodiments, the data can include signal strength values.

When signal strength values of APs are used for room proximity detection, a very common problem is that not every AP can be seen in every room. This can cause missing data in the data set obtained in operation 601. As the missing values in the dataset can affect the estimation of the information theory-based metrics, the measurement of the importance of APs can be distorted.

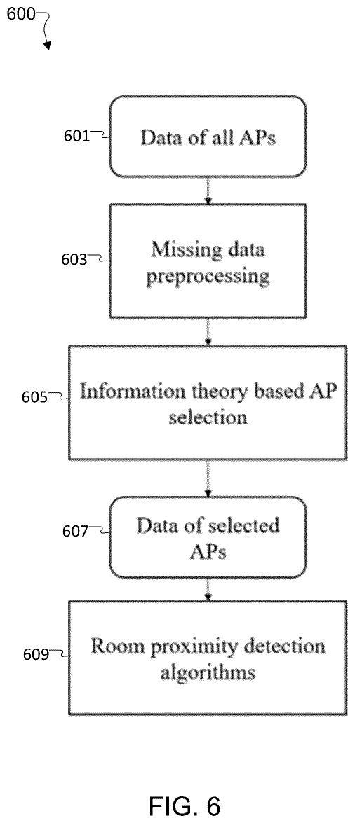

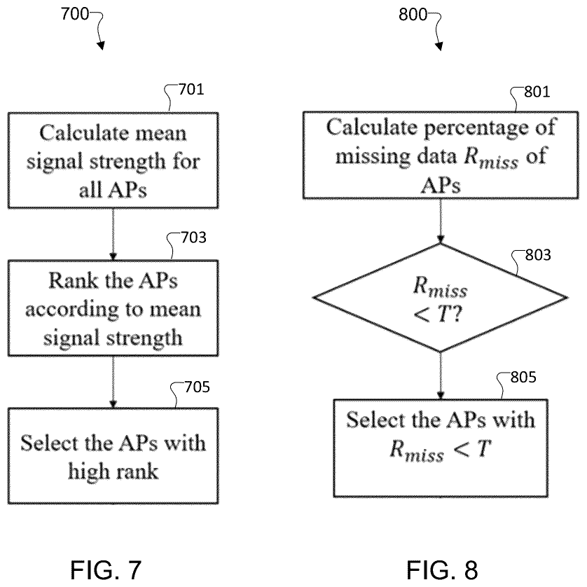

To address this issue, at operation 603, the data set is preprocessed to account for the missing data. In some embodiments, one or more of multiple methods can be applied to preprocess the missing values in the data set. The multiple methods include a Maxmean technique and missing data filtering, which are illustrated in FIGS. 7 and 8, respectively.

FIG. 7 illustrates an example process 700 for performing a Maxmean preprocessing technique according to embodiments of this disclosure. As shown in FIG. 7, the process 700 starts with operation 701, in which the mean signal strength of each AP across all locations (rooms) is calculated. At operation 703, the APs are ranked according to their mean signal strength across all locations (rooms). At operation 705, the APs with a high mean signal strength are selected. Only those APs with high mean signal strength will be considered in later AP selection steps.

FIG. 8 illustrates an example process 800 for performing a missing data filtering technique according to embodiments of this disclosure. As shown FIG. 8, the process 800 starts with operation 801, in which the percentage of missing data Rₘᵢₛₛ for each AP across all locations (rooms) is calculated. At operation 803, the percentage of missing data Rₘᵢₛₛ is compared to an empirically selected threshold T. At operation 805, the APs with missing data percentage lower than the threshold are selected. Only those selected APs will be considered in later AP selection steps.

Turning again to FIG. 6, in operation 605, information gain (also referred to as InfoGain) and mutual information are selected as the information theory-based metrics for AP selection. Additional details of these metrics will now be provided.

### InfoGain-Based AP Selection:

The InfoGain criterion for AP selection is to evaluate the worth of APs in terms of their discriminative power and select the highest ones. The discriminative power of an AP is measured by the information gain when its signal strength value is known. Specifically, the information gain is calculated as the reduction in entropy as follows:

$$InfoGain ( {AP}_{i} ) = H ( G ) - H ( G \vert {AP}_{i} )$$

where H(G) represents the entropy of user locations when the AP value is unknown. This entropy of user locations H(G) can be calculated as follows:

$$H ( G ) = - {\sum }_{j = 1}^{n} Pr ( {G}_{i} ) log Pr ( {G}_{i} )$$

where Pr(Gᵢ) is the prior probability that the user is in location (room) i, which can be uniformly distributed if a user can be equally likely in any room or estimated from the data set.

The conditional entropy of locations (rooms) given an AP's signal strength value is represented as H(G|APᵢ) and can be calculated as follows:

$$H ( G \vert {AP}_{i} ) = - {\sum }_{v} {\sum }_{j = 1}^{n} Pr ( {G}_{i} , {AP}_{i} = v ) log Pr ( {G}_{i} \vert {AP}_{i} = v )$$

where v is one possible value of signal strength from APᵢ and the summation is taken over all possible values of APᵢ.

The InfoGain-based AP selection can be implemented by the following steps:

(1). For each AP that passes the missing data preprocessing (in operation 603), calculate the information gain (InfoGain) value.

(2). The top k APs with the highest InfoGain value are selected.

### Mutual Information-Based AP Selection:

The mutual information metric can be used to measure how similar the information that two different APs have. If two APs contain very similar information that is useful for the room proximity detection task, then selecting one of them is enough. On the other hand, if two APs contain useful but very different information, it may be helpful to select both of them to improve the performance of room proximity. More generally, the mutual information between groups of APs can be measured in order to decide if a new group of APs should be selected. Concretely, the mutual information can be calculated as:

$$MI ( {AP}_{1} , {AP}_{2} ) = H ( {AP}_{1} ) + H ( {AP}_{2} ) - H ( {AP}_{1} , {AP}_{2} )$$

where H(AP₁) and H(AP₂) are the entropies of the signal strength values received from AP₁ and AP₂, respectively.

The joint entropy H of AP₁ and AP₂ can be calculated as:

$$H ( {AP}_{1} , {AP}_{2} ) = {\sum }_{{v}_{1}} {\sum }_{{v}_{2}} Pr ( {AP}_{1} = {v}_{1} , {AP}_{2} = {v}_{2} ) log Pr ( {AP}_{1} = {v}_{1} , {AP}_{2} = {v}_{2} )$$

where v₁ and v₂ are the possible signal strength values received from AP₁ and AP₂, and Pr(AP₁=v₁, AP₂=v₂) is the joint probability when AP₁=v₁, AP₂=v₂.

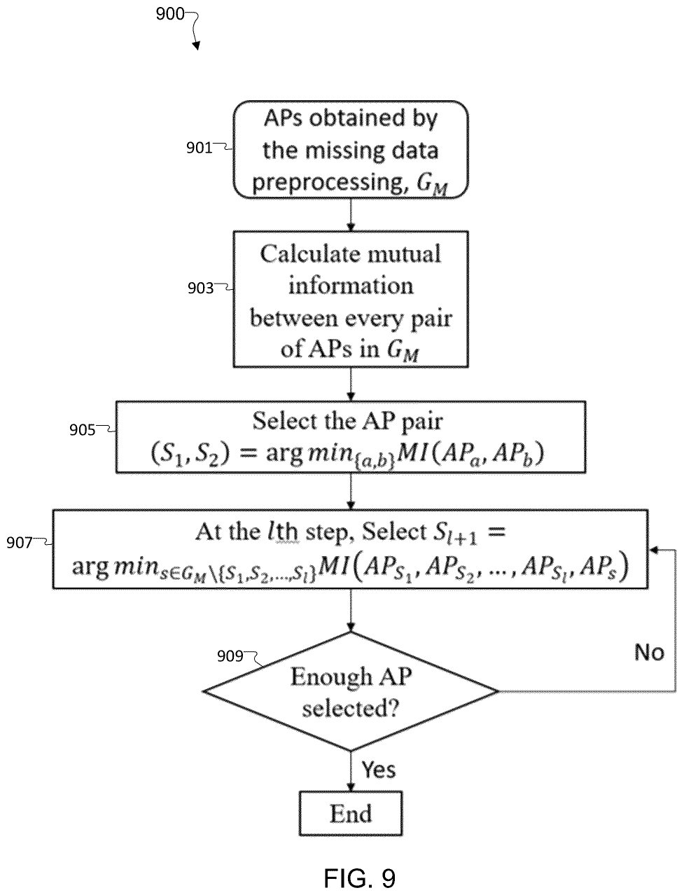

The process of mutual information-based AP selection is illustrated in FIG. 9.

FIG. 9 illustrates an example process 900 for mutual information-based AP selection according to embodiments of the present disclosure. The process 900 can be implemented as part of operation 605 of FIG. 6.

As shown in FIG. 9, the process 900 starts with operation 901, in which the APs that pass the missing data preprocessing, G_{M}, are obtained. At operation 903, the mutual information between each pair of available APs in G_{M} is calculated. At operation 905, an AP pair (S₁, S₂) is selected according to (S₁, S₂)=arg min_{{a,b}}MI(APₐ, AP_{b}). At operation 907, one more AP is selected at each step that has the smallest mutual information. For example, at the lth step, one more AP Sₗ₊₁ can be selected according to:

$${S}_{l + 1} = arg {min}_{s ∈ {G}_{M} \backslash \{ {S}_{1} , {S}_{2} , … , {S}_{l} \}} MI ( {AP}_{{S}_{1}} , {AP}_{{S}_{2}} , … , {AP}_{{S}_{l}} , {AP}_{s} ) ,$$

$$where$$

$$MI ( {AP}_{{S}_{1}} , {AP}_{{S}_{2}} , … , {AP}_{{S}_{l}} , {AP}_{s} ) = H ( {AP}_{{S}_{1}} , {AP}_{{S}_{2}} , … , {AP}_{{S}_{l}} ) + H ( {AP}_{s} ) - H ( {AP}_{{S}_{1}} , {AP}_{{S}_{2}} , … , {AP}_{{S}_{l}} , {AP}_{s} ) .$$

Here, {S₁, S₂, . . . , Sₗ} represent the APs selected in the previous (l−1) steps.

At operation 909, it is determined if the target number of APs has been selected. If not, the process 900 returns to operation 907 for selection of another AP. The process 900 ends when the target number of APs is reached.

Turning again to FIG. 6, once the APs have been selected in operation 605, then at operation 607, data is obtained from the selected APs. As discussed above, this data can include, e.g., signal strength data from the selected APs. At operation 609, one or more room proximity detection algorithms are performed. This can include using a ML localization algorithm to determine a proximity of a device within a building.

Although FIGS. 3 through 9 illustrate example techniques for access point selection for UE proximity detection and related details, various changes may be made to FIGS. 3 through 9. For example, various components in FIGS. 3 through 9 could be combined, further subdivided, or omitted and additional components could be added according to particular needs. In addition, while shown as a series of steps, various operations in FIGS. 3 through 9 could overlap, occur in parallel, occur in a different order, or occur any number of times. In another example, steps may be omitted or replaced by other steps.

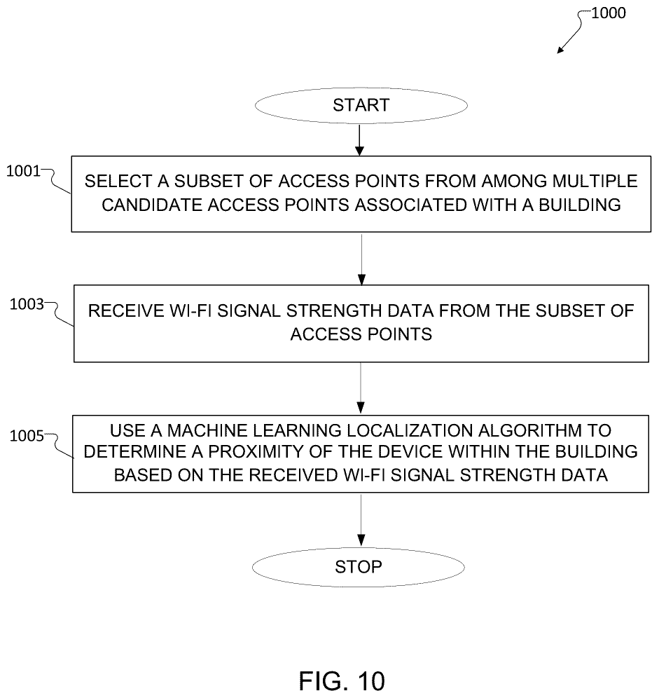

FIG. 10 illustrates a flow chart of a method 1000 for access point selection for UE proximity detection according to embodiments of the present disclosure, as may be performed by one or more components of the wireless network 100 (e.g., the AP 101 or the STA 111), which may represent a device in a building, such as the UE 306. The embodiment of the method 1000 shown in FIG. 10 is for illustration only. One or more of the components illustrated in FIG. 10 can be implemented in specialized circuitry configured to perform the noted functions or one or more of the components can be implemented by one or more processors executing instructions to perform the noted functions.

As illustrated in FIG. 10, the method 1000 begins at step 1001. At step 1001, a device selects a subset of access points from among multiple candidate access points associated with a building. In some embodiments, the subset of access points is selected based on clustering and similarity. In some embodiments, the subset of access points is selected by calculating information theory-based metrics. This could include, for example, the STA 111 selecting a subset of the APs 304 in the building 302 using either the process 500 of FIG. 5 or the process 600 of FIG. 6.

At step 1003, the device receives Wi-Fi signal strength data from the subset of access points. This could include, for example, the STA 111 receiving Wi-Fi signal strength data from the subset of APs 304 selected in step 1001.

At step 1005, the device uses a ML localization algorithm to determine a proximity of a device within the building based on the received Wi-Fi signal strength data. This could include, for example, the STA 111 using a ML localization algorithm to determine a proximity of the STA 111 within the building 302.

Although FIG. 10 illustrates one example of a method 1000 for access point selection for UE proximity detection, various changes may be made to FIG. 10. For example, while shown as a series of steps, various steps in FIG. 10 could overlap, occur in parallel, occur in a different order, or occur any number of times.

The embodiments described herein provide multiple advantageous benefits over conventional techniques, including higher accuracy in room proximity and lower power requirements. In addition, the disclosed embodiments can be used for a wide variety of use cases, including smart home devices with localization solutions.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
selecting a subset of access points from among multiple candidate access points associated with a building;
receiving Wi-Fi signal strength data from the subset of access points; and
using a machine learning (ML) localization algorithm to determine a proximity of a device within the building based on the received Wi-Fi signal strength data.

2. The method of claim 1, wherein the subset of access points is selected based on clustering and similarity.

3. The method of claim 1, wherein selecting the subset of access points from among the multiple candidate access points comprises:
calculating similarity measures between pairs of the candidate access points;
applying a clustering algorithm to the candidate access points to form clusters of access points based on the similarity measures;
randomly permuting the Wi-Fi signal strength data corresponding to each cluster; and
upon a determination that the randomly permuting of the Wi-Fi signal strength data for a particular cluster reduces an accuracy of the ML localization algorithm, adding the particular cluster to the subset of access points.

4. The method of claim 3, wherein each of the similarity measures is calculated using a Pearson correlation or a Kendall rank coefficient.

5. The method of claim 1, wherein the subset of access points is selected by calculating information theory-based metrics.

6. The method of claim 5, wherein the information theory-based metrics comprise information gain metrics or mutual information metrics.

7. The method of claim 5, further comprising:
preprocessing the Wi-Fi signal strength data using a Maxmean technique or a missing data filtering technique.

8. A device comprising:
a transceiver; and
a processor operably connected to the transceiver, the processor configured to:
select a subset of access points from among multiple candidate access points associated with a building;
receive Wi-Fi signal strength data from the subset of access points; and
use a machine learning (ML) localization algorithm to determine a proximity of the device within the building based on the received Wi-Fi signal strength data.

9. The device of claim 8, wherein the processor is configured to select the subset of access points based on clustering and similarity.

10. The device of claim 8, wherein to select the subset of access points from among the multiple candidate access points, the processor is configured to:
calculate similarity measures between pairs of the candidate access points;
apply a clustering algorithm to the candidate access points to form clusters of access points based on the similarity measures;
randomly permute the Wi-Fi signal strength data corresponding to each cluster; and
upon a determination that the randomly permuting of the Wi-Fi signal strength data for a particular cluster reduces an accuracy of the ML localization algorithm, add the particular cluster to the subset of access points.

11. The device of claim 10, wherein the processor is configured to calculate each of the similarity measures using a Pearson correlation or a Kendall rank coefficient.

12. The device of claim 8, wherein the processor is configured to select the subset of access points by calculating information theory-based metrics.

13. The device of claim 12, wherein the information theory-based metrics comprise information gain metrics or mutual information metrics.

14. The device of claim 12, wherein the processor is further configured to:
preprocess the Wi-Fi signal strength data using a Maxmean technique or a missing data filtering technique.

15. A non-transitory computer readable medium comprising program code that, when executed by a processor of a device, causes the device to:
select a subset of access points from among multiple candidate access points associated with a building;
receive Wi-Fi signal strength data from the subset of access points; and
use a machine learning (ML) localization algorithm to determine a proximity of the device within the building based on the received Wi-Fi signal strength data.

16. The non-transitory computer readable medium of claim 15, wherein the program code causes to the device to select the subset of access points based on clustering and similarity.

17. The non-transitory computer readable medium of claim 15, wherein the program code to select the subset of access points from among the multiple candidate access points comprises program code to:
calculate similarity measures between pairs of the candidate access points;
apply a clustering algorithm to the candidate access points to form clusters of access points based on the similarity measures;
randomly permute the Wi-Fi signal strength data corresponding to each cluster; and
upon a determination that the randomly permuting of the Wi-Fi signal strength data for a particular cluster reduces an accuracy of the ML localization algorithm, add the particular cluster to the subset of access points.

18. The non-transitory computer readable medium of claim 17, wherein the program code causes to the device to calculate each of the similarity measures using a Pearson correlation or a Kendall rank coefficient.

19. The non-transitory computer readable medium of claim 15, wherein the program code causes to the device to select the subset of access points by calculating information theory-based metrics.

20. The non-transitory computer readable medium of claim 19, wherein the information theory-based metrics comprise information gain metrics or mutual information metrics.
